(19) United States
(12) Patent Application Publication
(10) Pub. No.: US 2017/0322151 A1
(43) Pub. Date: Nov. 9, 2017

(54) Interferometric System and Method of Measurement of Refractive Index Spatial Distribution

(71) Applicant: VYSOKE UCENI TECHNICKE V BRNE, Brno (CZ)

(72) Inventors: Pavel KOLMAN, Dacice (CZ); Radim CHMELIK, Brno (CZ)

(73) Assignee: VYSOKE UCENI TECHNICKE V BRNE, Brno (CZ)

(21) Appl. No.: 15/520,293

(22) PCT Filed: Oct. 5, 2015
(86) PCT No.: PCT/CZ2015/000117

§ 371 Date: Apr. 19, 2017

(30) Foreign Application Priority Data
Oct. 20, 2014 (CZ) PV 2014-714

(51) Int. Cl. G01N 21/45; G01N 21/64; G02B 21/00

(52) U.S. Cl. CPC G01N 21/453; G01N 21/6458; G01N 21/45; G01N 21/64; G02B 21/00

(57) ABSTRACT

An interferometric system and a method of measurement of refractive index spatial distribution for use in digital holographic microscopy to observe samples in reflected as well as transmitted radiation or to observe luminescent samples comprises a first branch and a second branch with a plurality of optical elements. The first branch comprises a diffraction grating located in a plane optically conjugated with the object plane in order to create an achromatic hologram with spatial carrier frequency in the output image plane.

### FIELD OF THE INVENTION

The present invention relates to interferometric system and method of measurement of refractive index spatial distribution applicable in digital holographic microscopy to observe samples in reflected and transmitted light or to observe luminescent samples.

### BACKGROUND OF THE INVENTION

In present, several arrangements of interferometric systems based on interferometer employing diffraction grating are known.

Examples of such arrangements are disclosed for example in utility models CZ 8547, CZ 19150 and in the patent application CZ P 302491. These systems use interference of two mutually coherent beams, wherein the first one is affected by the observed object and the second one passes the object. Two mutually coherent beams are formed by splitting the illumination beam from the external source.

It has not been possible to apply advantages of the holographic imaging for fluorescent objects in these arrangements. In case of fluorescence, the source of radiation is the sample itself, which could have been placed only in one arm, and the light emitted by the sample was not coherent with the light in the reference arm and therefore no interference image (interferogram) could be created. The previous systems of the proprietor allow imaging using light emitted by the observed object merely the same way as in usual (non-confocal=epifluorescence) fluorescence microscope, i.e. so that only one arm of the interferometer is used for imaging, no hologram is formed in the plane of the detector, and the intensity of the light emitted by sources from the whole volume of the object is always imaged without the possibility to obtain complete information about the object wave, i.e. its amplitude and phase, and without the possibility of depth resolution, i.e. no optical sections through the sample are created.

Confocal microscopes, in which it is necessary to scan a single point or a group of points in a sufficient distance from each other, which is time demanding, are usually used to create optical sections in the whole field of view. Moreover, it is not possible to obtain quantitative phase imaging.

Other examples are disclosed in patent documents U.S. Pat. No. 5,671,085 and US2008158551. In these documents, the interferometer is in axial configuration, where axes of both beams are parallel and coincide in the plane of the detector. Devices disclosed in these patent documents are achromatic, which means that the source of radiation may be polychromatic. The main drawback described in these documents is that it is necessary, in order to obtain complete information about the object wave (its amplitude and phase), to record several interferograms (at least three) differing from each other in the transmission periods difference of the emitted radiation in the first and the second arm. There are several methods of recording and reconstruction that differ in a number of interferograms which have to be recorded, and in the shift (step) of the transmission periods differences with smaller number of records, the shift (step) between the particular interferograms has to be known and precisely set value (an error in the setting adversely affects the accuracy of the obtained information especially the phase), with greater number of records it is not necessary to set a precise value of the shift (step) between particular interferograms. To set the shift (step), various devices allowing to change the optical path length of an arm are used (mirror, system of mirrors, system of wedge plates, etc.).

The apparatus disclosed in U.S. Pat. No. 5,671,085 comprises only one detector, which requires time-lapse sequence recording that practically limits the use of such apparatus on static objects.

The precision of the apparatus (the accuracy of the obtained information especially the phase) is affected also by the turbulences of air or of media surrounding the sample, as the difference between transmission periods of waves passing through the first arm and waves passing through the second arm changes randomly in time (moreover, differently for different pixels of an interferogram), and thus adds a random and unknown function to the input data (interferogram) used for calculation of the amplitude and phase, and increases the inaccuracy (error) in the calculations.

System disclosed in the patent document US2008158551 uses a beam combiner (splitter), which splits the beams from the first and the second arm and guides them simultaneously to several detectors. Beam combiner provides temporally-constant difference of variances of the transmission periods between the first and the second arm, different for different detectors. All detectors can record synchronously. Contrary to the apparatus disclosed in U.S. Pat. No. 5,671,085, the accuracy of the measurement is not affected by the turbulences in the surrounding environment. A drawback of this system is that the beam combiner may introduce such aberrations into the process of imaging that are related to its construction, e.g. the intensity ratio of the radiation incident on various detectors may depend on wavelength of radiation (according to the structure of interference layers superposed on the active surfaces of the beam combiner—the production of layers is financially demanding, the layers are designed for a limited spectral interval, transmittance/reflectance is not constant in the given interval). Another drawback is that all detectors have to image the same plane (it is necessary to align detectors in the direction perpendicular to the plane of the detector and to align tilt of the plane of detector), the same field of view (it is necessary to shift detectors in the direction parallel to the plane of the detector), and also the same magnification between the object plane and the detector plane has to be provided for all detectors, which is actually very difficult to ensure. Inaccurate alignment can be partially corrected by numerical pre-processing, which increases the time required for calculation.

### SUMMARY OF THE INVENTION

The said drawbacks are eliminated by the method of measurement of refractive index spatial distribution of the sample in interferometric system comprising an external radiation source, the first arm and the second arm, a system of reflectors and a detector provided in the output image plane and connected to a computing unit, where the first arm comprises the first input image system and the first output image system, and the second arm comprises the second input image system, wherein the first input image system and the second input image system are arranged in one axis z against each other in such way that they have a common object plane, in which a luminescent sample is placed, and which is optically conjugated with the output image plane, characterized in that it comprises a step of excitation of luminescent particles contained in the sample by means of external source of radiation, wherein the luminescent particles emit their own radiation, and this emitted radiation then passes through the first arm and the second arm and reaches the detector, where it interferes with radiation from both of the arms; a step of recording the first interferogram on the detector and saving it in a computing unit, a step of shifting the sample in the direction of mutual axis z of input image systems in relation to the object plane, a step of capturing the second interferogram and saving in a computing unit, a step of calculating the amplitude of waves emitted by the sample and a difference of phases between the first and the second arm from the first and the second interferogram, and a step of calculating an mean value of the refractive index in the volume element determined by the size of the picture element and the size of the said shift of the sample in the axis z.

In a preferred embodiment, the calculation of the average refractive index value n̅ᵢ(x,y) is carried out in the said volume element using the relation:

$${\overline{n}}_{i} ( x , y ) = \frac{Δ {OPD}_{i} ( x , y )}{2 Δ {z}_{i}} + {n}_{0} = \frac{{Δψ}_{i} ( x , y ) λ}{4 π Δ {z}_{i}} + {n}_{0} ,$$

where ΔOPDᵢ is the variation of optical paths difference, n₀ is refractive index of the environment surrounding the sample, Δzᵢ is the size of the shift of the sample along the axis z, λ is wavelength of the radiation emitted by the sample, Δψᵢ is the variation of the difference of phases in the interval Δzᵢ.

In another preferred embodiment, a picture element of the first and the second phase image with the same coordinates (x,y) is used to calculate the difference of the phases.

Drawbacks of the systems known in the art are further eliminated by interferometric system comprising the external source of radiation, the first arm and the second arm, a system of reflectors, and a detector arranged in the output image plane, where the first arm comprises the first input image system and the first output image system, and the second arm comprises the second input image system, wherein the first input image system and the second input image system are arranged in one axis against each other so that they have a mutual object plane conjugated with the output image plane, characterized in that there is further comprised at least one diffraction grating in the plane optically conjugated with the object plane in order to create achromatic hologram with spatial carrier frequency in the output image plane.

In a preferred embodiment, there is the system of reflectors aligned in such manner that a non-zero diffraction order of radiation diffracted by the said diffraction grating is directed to the detector.

In order to obtain visual information, the interferometric system may use radiation from the external source, which interacted with the sample or the radiation emitted by the sample itself.

Other embodiments may comprise various types of diffraction gratings, which can be designed as replaceable ones.

Other advantages and benefits of this invention will be apparent after close reading of the embodiment examples with respective references to the accompanying drawings.

### DESCRIPTION OF THE DRAWINGS

FIG. 1 is a schematic illustration of an example of a preferred embodiment of interferometric system

FIG. 2 is a schematic illustration of the second example of a preferred embodiment of interferometric system

FIG. 3 is a schematic illustration of the third example of a preferred embodiment of interferometric system

FIG. 4 is a schematic illustration of the fourth example of a preferred embodiment of interferometric system

FIG. 5 is a schematic illustration of the fifth example of a preferred embodiment of interferometric system

FIG. 6 is a schematic illustration of the sixth example of a preferred embodiment of interferometric system

FIG. 7 is a schematic illustration of the seventh example of a preferred embodiment of interferometric system

FIG. 8 is a schematic illustration of the eighth example of a preferred embodiment of interferometric system

FIG. 9 is an example of holographic record processing in order to obtain the amplitude image (complex amplitude modulus) and the phase image (complex amplitude argument)

FIG. 10 is an illustration of a sliding panel for replacement of diffraction gratings

FIG. 11 is an illustration of the rotational panel for replacement of diffraction gratings

FIG. 12 a) schematic representation of optical paths of the first and the second arm of imaging interferometer with a present object, b) shifting the object for Δzᵢ, c) process of the refractive index in selected picture element along the axis z and an average refractive index n̅ᵢ in the interval Δzᵢ, d) process of the difference of phases φ between the first and the second arm depending on the position of the object along the axis z, e) process of the function φ=mod_{2π}(φ), which represents modulo 2π of the difference of the phases φ, f) sampled values of the function φ.

### EXAMPLES OF PREFERRED EMBODIMENTS

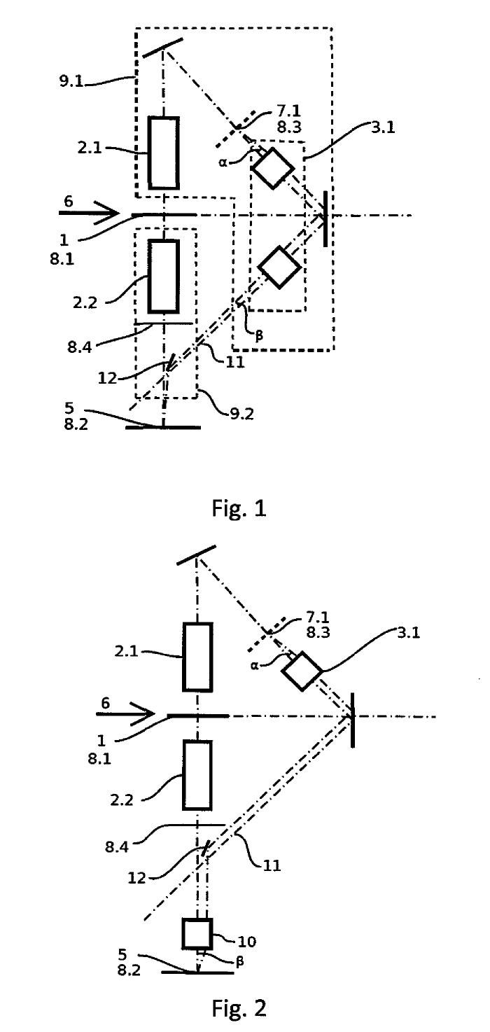

An example of preferred embodiment of interferometric system is schematically illustrated in the FIG. 1. It is a representation of interferometric system for formation of hologram of a luminescent sample 1 or a sample 1 illuminated by a suitable external source of radiation.

Luminescent sample 1 is usually a fluorescent sample, i.e. luminescent particles are the particles of fluorescent dye contained in the sample 1. Other possible examples of luminescent sample 1 comprise e.g. autofluorescence or phosphorescence. Suitable examples of such sample 1 are plant and animal cells, clusters of cells, microorganisms or technical microobjects. Observation of luminescent sample particles takes place only after their excitation (illumination) using external source of radiation. Further, in the examples of the invention embodiments, examples with the fluorescent dye will be described. It is assumed that a person skilled in the art is able to apply the mentioned examples also on other types of luminescence.

In case of the sample 1 illuminated by a suitable external source of radiation is a sample illuminated by e.g. temporally or spatially incoherent external radiation source, wherein the radiation, which interacted with the sample 1 is observed. Interaction means, for example, reflection, diffraction, dispersion, absorption, or phase shift. This is used in case of samples 1 which do not exhibit luminescence.

FIG. 1 represents an example of interferometric system consisting of an external radiation source (not shown), the first arm 9.1 the second arm 9.2 transmission system of reflectors and a detector 5.

The first and the second arm al., 9.2) origin in the object plane 8.1 and end in the output image plane 8.2. In general, the first and the second arm (9.1, 9.2) in various embodiments comprise a plurality of optical elements, comprising for example a reflector or lens as well as more complex optical elements, such as objective lens, elements with adjustable focal length, a deflector, system of reflectors, element with fixed optical length or extenders.

The object plane 8.1 passes through the sample 1. The first arm 9.1 and the second arm 9.2 have approximately the same optical path length and approximately the same magnification, from the beginning to the end of the arm. Difference between the transmission period of the radiation in the first arm 9.1 and in the second arm 9.2 is therefore smaller than the coherence time of radiation. This may be applied in the system in the FIG. 1 in such a way that the optical lengths of elements in both arms are chosen so as to compensate various geometric lengths of arms as well as the use of various imaging systems, or an extender 4.1 (4.2) may be used for setting of identical optical path lengths, as it is disclosed in other embodiments. Magnification in the first arm 9.1 and the second arm 9.2 from the object plane 8.1 up to the output image plane 8.2 is approximately the same, and the first output image created in the first arm 91 in the output image plane 8.2 and the second image created by the second arm 9.2 in the o output image plane 8.2 substantially overlap, which may provide interference of radiation from both of the arms.

External source of radiation is attached to allow illuminating the sample 1 arranged in the object plane 8.1. This may be done, for example, by illuminating through one input imaging system or through both input imaging systems at the same time, wherein the radiation passing against each other from the external source in the environment of the object plane 8.1 constructively interferes, or by illuminating the sample 1 with a light-sheet outside the input imaging systems directly in the object plane 8.1. External source of radiation illuminating the sample 1 may be a source with optional level of temporal and spatial coherence. The arrow in the picture represents optional radiation from the external source 6.

In the first arm 9.1 the first input imaging system 2.1 and the first output imaging system 3.1 are arranged. The first primary image plane 8.3 is optically conjugated with the object plane 8.1 through the first output imaging system 2.1 and with the output image plane 8.2 through the first output imaging system 3.1.

In the second arm 9.2 the second input imaging system 2.2 is arranged. The output image plane 8.2 is optically conjugated with the object plane 8.1 through the second input imaging system 2.2. The said input imaging systems in this embodiment are composed from objective lenses forming an image in infinite distance as well as objective lenses imaging in finite distance. In other embodiments, only one of the said types of objective lenses or their optional combination may be used. The objective lens represents the first imaging element arranged behind the observed object, which creates its image in finite or infinite distance behind this imaging element, or a component intended for this use. The first input imaging system 21 and the second input imaging system 2.2 are arranged in the same axis against each other in such way that they have mutual object plane 8.1. Optical axes of the first output imaging system 3.1 and the second input imaging system 2.2 coincide in the plane of the detector and they are parallel with the normal of the detector. In this embodiment, the first output imaging system 3.1 consists of two optical elements, with a reflector in between, as it is illustrated in the FIG. 1. E.g. the first optical element of the first output imaging system 3.1 is arranged so that its front focus lies near the first primary image plane 8.3 and the second optical element of the first output imaging system 3.1 is arranged in such way that the back focus lies near the output image plane 8.2.

The most important element of interferometric system is the first diffraction grating 7.1 which is arranged near the first primary image plane 8.3 in this embodiment.

The light beam in the first arm 9.1 of which the axis is unified with the axis of the first input imaging system al., exits this imaging system 2.1 and is directed towards the first primary image plane 8.3 is diffracted on the first diffraction grating 7.1 and it further continues towards the first output imaging system 3.1.

Generally, the beam axis behind the diffraction grating 7.1 is deflected from the axis of the first output imaging system 3.1 at the angle α₁, for which it applies that sin(α₁)=sλf, where s is an integer number which represents diffraction order, λ is wavelength of the diffracted radiation and f is spatial frequency of the diffraction grating (groove density).

In case of zero diffraction order, s=0, i.e. also α₁=0, and the axis of the beam in zero diffraction order 11 is collinear behind the diffraction grating with the axis of the first output imaging system 3.1. The mirror 12 is placed in such an angle that, in case it would be bigger and it would reflect also the beam in zero diffraction order, the axis of this beam would be parallel to the normal of the output image plane 8.2. Of course, because it is desirable to direct only one diffraction order on the detector 5 which is other than the zero order, i.e. for example, the first order, the dimensions and position of the mirror is chosen so that it would filtrate the beams of other diffraction orders including the zero order, as it is apparent from the figures. Alternatively, this can be achieved also by using attenuators located in the beam path.

In case of first diffraction order it applies that s=1, i.e. α₁≠0, and the axis of the beam in the first diffraction order is deflected behind the diffraction grating at a non-zero angle α₁ in relation to the axis of the first output imaging system 3.1. Light beam diffracted by the diffraction grating 7.1 at a non-zero angle α₁ then enters the first output imaging system 3.1 with axis deflected at the same angle α₁ in relation to the optical axis of the first output imaging system 3.1, and exits the output imaging system 3.1 with the axis inclined to the optical axis of the first output imaging system 3.1 at a non-zero angle β₁ and then enters the output image plane 8.2 of interferometer with the axis also inclined at the same angle β₁ in relation to the normal of the output image plane 8.2.

For the angles α₁ and β₁ it applies that sin(β₁)=sin(α₁)/m₁, where m₁ is the magnification of the first output imaging system 3.1.

Other diffraction orders, especially zero and the second order, usually appear behind the grating and their relative intensity varies with wavelength, however, they are not used for imaging in this embodiment. In an alternative embodiment it is possible to work with different order, for example the second diffraction order, and eliminate other orders.

Radiation beam in the second arm 9.2 of which the axis is collinear with the axis of the second imaging system 2.2 leaves this imaging system 2.2 and continues towards the output image plane 8.2. The normal of the output image plane 8.2 is parallel with the axis of the second input imaging system 2.2.

In the output image plane 8.2 the beam axis of the first arm 91 and the beam axis of the second arm 9.2 together generally form a non-zero angle β₁, for which it applies that

$$sin ( {β}_{1} ) = \frac{sin ( {α}_{1} )}{{m}_{1}} = \frac{s λ f}{{m}_{1}} .$$

The beam of the first arm 9.1 and the beam of the second arm 9.2 are mutually coherent, interfere with one another, and in the output image plane 8.2 an interferogram with spatial carrier frequency

$$\frac{sf}{{m}_{1}}$$

independent from the wavelength (i.e. interferogram is achromatic) is formed. Spatial carrier frequency of the interferogram is independent from the position of the source of radiation in the object plane 8.1 i.e. the present interferometric system is spatially invariant. Detector 5 is located in the output image plane 8.2.

In other embodiments, the diffraction grating 7 may be arranged in the second arm 9.2 or eventually in both arms. Frequency f of the diffraction grating 7 has to be higher than the quadruple of the reciprocal of the product of the minimum wavelength λₘᵢₙ, for which the diffraction grating 7 is intended and numerical aperture NA_{d} of the beam reaching the diffraction grating 7, thus it has to apply that

$$f \geq \frac{4}{{λ}_{min} {NA}_{d}} .$$

The interferogram is then a hologram.

In the embodiment in the FIG. 1, a transmission diffraction grating 7 is used, alternatively it is also possible to use reflexive diffraction grating 7.

The example in the FIG. 2 is an analogy to the above described system illustrated in the FIG. 1, with the difference that the first output image system 3.1 images in infinity, and also a mutual imaging system 10 is added, which may be, for example, in the form of an optical lens with variable focal length.

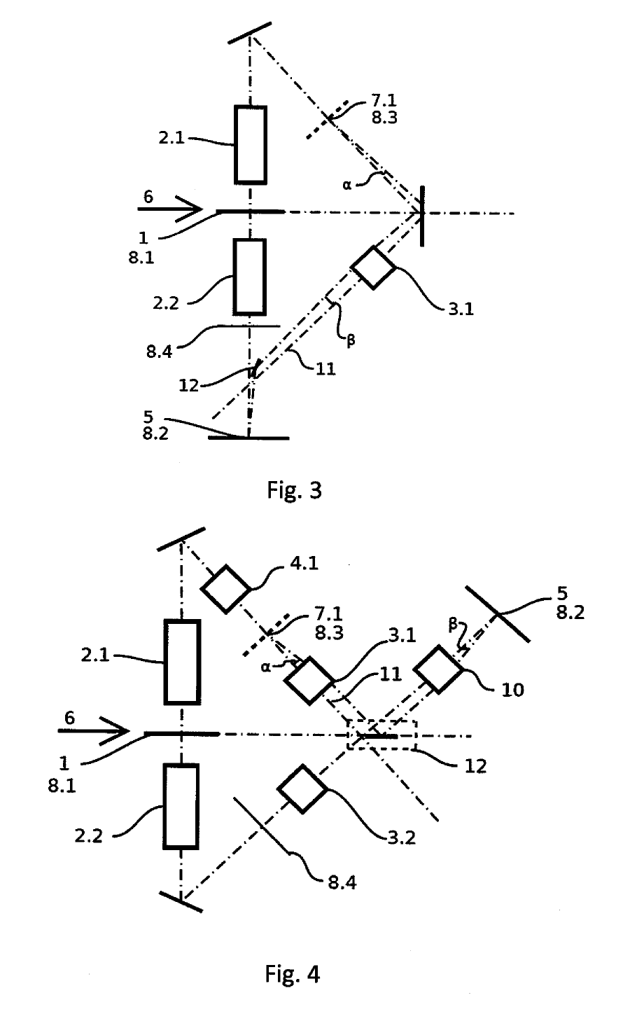

Another example in the FIG. 3 is a similar system as the one illustrated in the FIG. 1 with the difference that the used first output imaging system 3.1 images in a finite distance.

In the FIG. 4 is shown an analogy to the above described system illustrated in the FIG. 3. The first arm 9.1 and the second arm 9.2 origin in the object plane 8.1 in which a sample 1 is arranged, and they end in the output image plane 8.2. In the first arm 9.1 the first input imaging system 2.1 and the first output imaging system 3.1, and the extender 4.1 are arranged. The first primary image plane 8.3 is optically conjugated with the object plane 8.1 through the first input imaging system 2.1 and with the output image plane 8.2 through the first output imaging system 3.1.

The extender 4.1 serves to set identical optical path length of both arms, and it may also extend or shorten the optical path length, therefore it is apparent that in other embodiment may be the extender 4.1 arranged only in the second arm 9.2 or in both arms.

The second input imaging system 2.2 and the second output imaging system 3.2 are arranged in the second arm 9.2. The second primary image plane 8.4 is optically conjugated with the object plane 8.1 through the second input imaging system 2.2, and with the output image plane 8.2 through the second output imaging system 3.2.

The said imaging systems consist of objective lenses imaging in infinity or in finite distance, or other optional combinations thereof. As it will be described further in the description of the invention, the output imaging systems (3.1 a 3.2) of both arms may comprise a few mutual elements. In this example of the embodiment, they comprise a mutual imaging system 1.0, which may be in a form of objective lens with variable focal length (also referred to as zoom lens or zoom). The first input imaging system 2.1 and the second input imaging system 2.2 are arranged along one axis against each other, so that they have a mutual object plane 8.1.

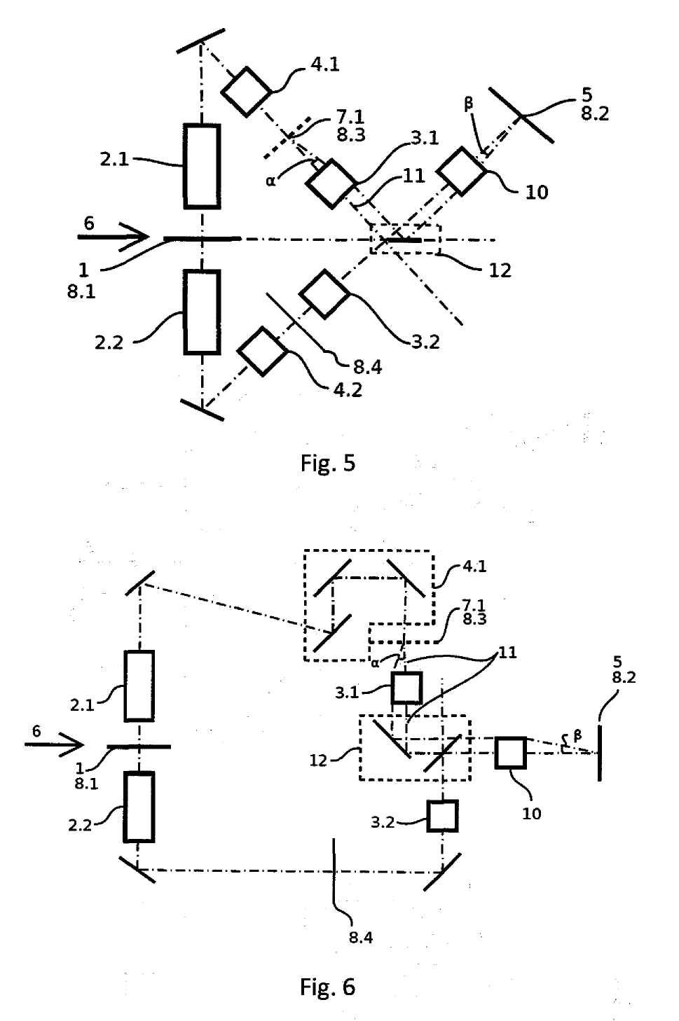

The example in the FIG. 5 is an analogy to the above described system illustrated in the FIG. 4 with the difference that the extender 4.2 is arranged in the second arm.

The example in the FIG. 6 is an example of another spatial arrangement of the system illustrated in the FIG. 4, with the difference that the first arm 9.1, besides the first input imaging system 2.1, diffraction grating 7.1 and the first output imaging system 3.1 also comprises the first extender 4.1 consisting of transmission system of reflectors. Further, the second arm 9.2 accordingly comprises the second input imaging system 2.2 and the second output imaging system 3.2. Both systems comprise a mutual imaging system 10 which directs the illumination from both arms towards the detector 5.

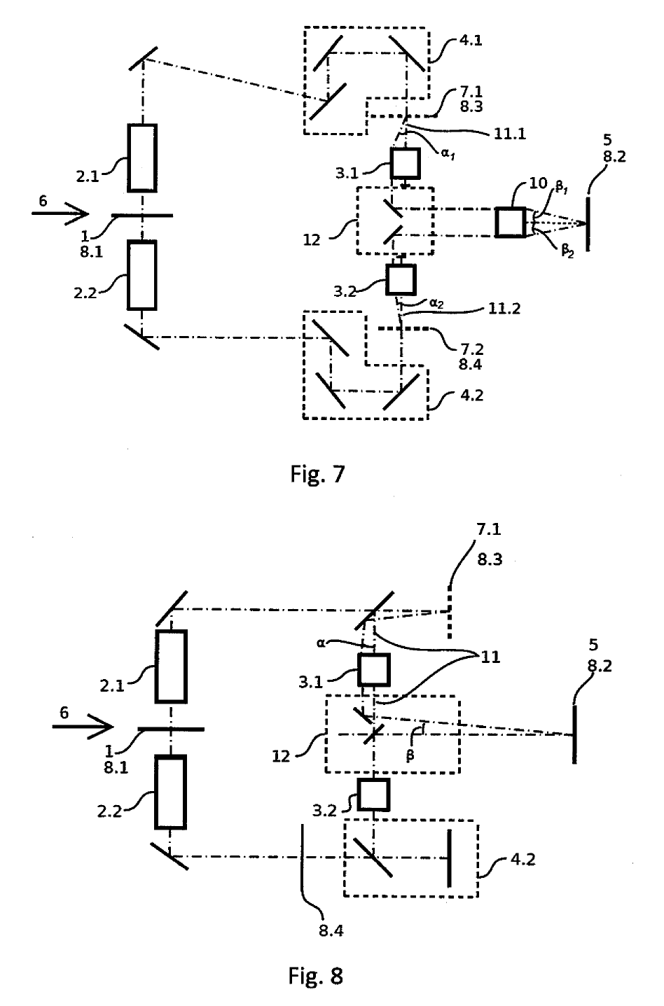

Another example of the interferometric system embodiments according to the invention is illustrated in the FIG. 7. It is an analogy to the above described system illustrated in the FIG. 6 with the difference that in both the first and the second arm a diffraction grating (7.1 and 7.2) is arranged. It is thus an arrangement, in which the first diffraction grating 7.1 is arranged close to the first primary image plane 8.3 and the second diffraction grating 7.2 is arranged close to the second primary image plane 8.4. The extenders 4.1 and 4.2 may be realized in many ways. In this embodiment, they consist of transmission system of reflectors.

For the angles α₂ and β₂ applies the same relation than for the angles α₁ and β₁ described above in the embodiment example in the FIG. 1.

Another example of the interferometric system embodiment according to the invention is illustrated in the FIG. 8. It is an analogy to the above described system illustrated in the FIG. 6 with the difference that in the second arm 9.2 the extender 4.2 of a different type is used and the transmission diffraction grating 7.1 is replaced with reflection diffraction grating 7.1. Reflection diffraction grating 7.1 might be used in all the above mentioned examples of the embodiment.

Relative intensity of diffraction orders depends on the wavelength of the diffracted radiation. The diffraction grating 7 might be preferably designed so as the efficiency of the grating would be maximum for the used diffraction order (e.g. blazed grating). This applies only to one wavelength, the efficiency of the used diffraction order decreases for other wavelengths, and on the other hand, the relative intensity of the unused orders increases. It is therefore advantageous if the diffraction grating is arranged replaceably, so that the interferometric system might be adjusted to the wavelength of the radiation reaching the diffraction grating.

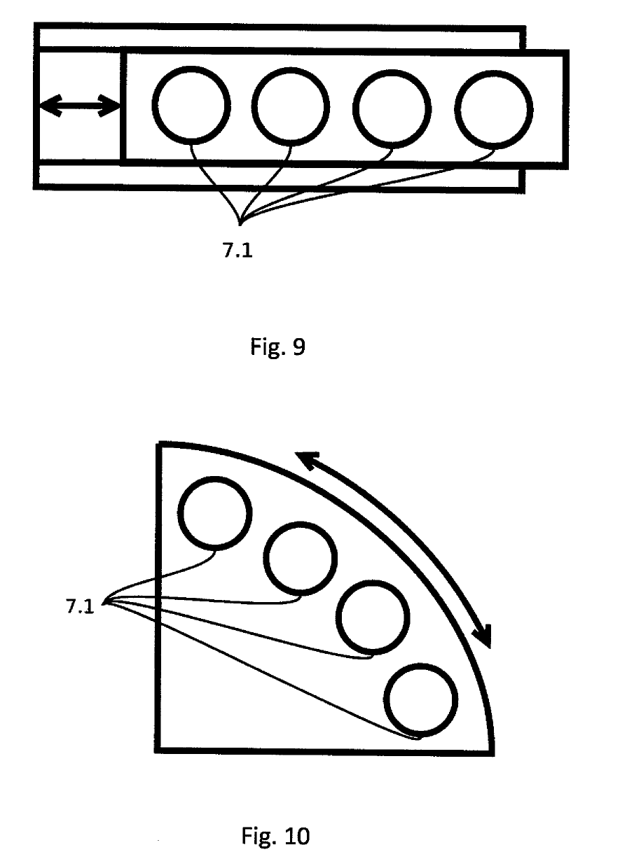

In a preferred embodiment, the diffraction grating 7 is arranged on a rectangular-shaped panel, onto which several diffraction gratings 7 might be arranged. Replacing of the diffraction grating 7 is done by sliding the panel with diffraction gratings 7 either manually or using any kind of actuator. The FIG. 9 shows an example of a sliding panel with diffraction grating 7.

In another embodiment, the diffraction grating 7 is arranged on a circular shaped panel, onto which several diffraction gratings 7 might be arranged. Replacement of the diffraction grating is done by rotating the panel with diffraction gratings 7, either manually or by using any kind of actuator. The FIG. 10 shows an example of rotating panel with the diffraction grating 7.

When operating in fluorescence mode, the particles of fluorescent dye contained in the sample 1 inserted between the first input imaging system 2.1 and the second input imaging system 2.2 in the object plane 8.1 are excited by the external source of radiation subsequently emitting their own radiation. Radiation emitted by the particles of fluorescent dye in the sample 1 is temporally incoherent. Its spectral width varies between several to tens of manometers. Moreover, the particular fluorescent dye particles emit mutually incoherent radiation. Fluorescent sample 1 thus macroscopically behaves as a broadband (temporally incoherent) volumetric spatially incoherent source of radiation. The emitted radiation spreads in all directions, passes through the first arm 9.1 and the second arm 9.2 and reaches the reflector 5 where it interferes together with radiation emitted by both arms, while the detector 5 records the resulting interferogram, which is an achromatic off-axis hologram thanks to the interferometric system construction. Interferometric system is spatially invariant in the sense that the resulting hologram has spatial carrier frequency independent from the position of the source of radiation.

The output transmission system of reflectors 12 (see FIG. 8) directs the radiation towards the detector 5. This system might be carried out in many ways. The detector 5 is usually designed as a planar detector 5 e.g. as a CCD sensor. As it has been pointed out in the previous description, interference might occur only in case the difference of optical paths of radiation emitted by the particles of fluorescent dye in both arms of interferometric system is smaller than the coherence length of this radiation. A computing unit (not shown), which might be in the form of a standard computer, is connected to the detector 5.

For example, using the above described examples of interferometric system, it is possible to implement the method of measurement of refractive index spatial distribution. Initially, the intensity of the interference in the first and the second arm 9.1 and 9.2 i.e. the interferogram which is further recorded in the computing unit, is recorded on the detector 5. In the interferometric system of the present invention, the recorded interferogram is a hologram, i.e it contains the complete information about the object wave (its amplitude and phase). In other systems known in the art, it is necessary to record several interferograms and to subsequently reconstruct the object wave (its amplitude and phase).

Reconstruction of the object wave's amplitude and phase might be carried out in several ways, which differ mainly in the used interferometric system, and at the same time it is possible to use various numerical methods for a single type of interferometer. In the interferometric system of the present invention, for example, filtration of the hologram's spatial frequencies spectrum in the Fourier environment is used. The spectrum of spatial frequencies of the hologram might be obtained e.g. using 2D discrete Fourier transform. In the sideband of the spatial frequencies spectrum, a section is made around the area of hologram's spatial carrier frequency and 2D discrete Fourier transform is carried out in this area. The spatial carrier frequency is the frequency in which the frequency spectrum reaches its maximum in the sideband. The size of the section is determined by a circle with the centre in the carrier frequency and by the radius proportional to

$$\frac{2 {NA}_{O}}{m {λ}_{min}} ,$$

where NA_{O} is numerical aperture of the objective lens, λₘᵢₙ is the minimum wavelength of the emitted radiation, and m is the total magnification between the object plane 8.1 and the output image plane 8.2.

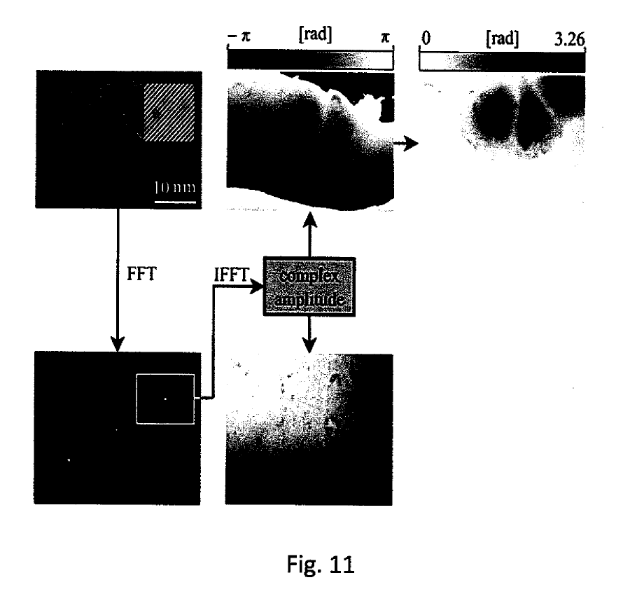

The result of the inverse Fourier transform is the complex amplitude of the object wave, of which the modulus determines the real amplitude of the object wave and the argument of complex amplitude determines the phase of object wave. The calculated phase values are limited to the interval <−π; π>. For the correct display and interpretation of the phase it is necessary to remove the phase discontinuities (unwrap the phase) by adding the 2π value multiples. The FIG. 11 illustrates the holographic signal processing described above.

Holographic signal can therefore be derived from the theory of interference of radiation, e.g. by the process described above. To summarize the abovementioned process, the phase image and amplitude image is obtained by the numerical processing. Numerical processing comprises the step of Fourier transform, filtration of spatial frequencies spectrum, as well as inverse Fourier transform. The result is the complex amplitude of the signal, the modulus of which represents the amplitude and the argument represents its phase.

Other methods of calculation of amplitude and phase of the object wave do not need to be described, because they are well known in the art. It will be further proceeded similarly with the various systems.

In the following step, the sample 1 is shifted in the direction of the axis z and the second interferogram is recorded, which is further recorded in the computing unit. Using this method of shifting the sample 1 in the direction of the optical axis z over the intervals of the length of Δzᵢ, it is possible to obtain a set of N holograms, wherein the index i=1, 2, . . . , N−1 represents the sequence number of the shifting interval between i and (i+1) record of the hologram. The shift Δzᵢ may vary for different scans, it is therefore differentiated via the index i. Amplitude image creates an optical section. It images only that part of the sample 1 which lies near the common object plane 8.1. Using the set of these sections (set of N images) it is possible to construct the spatial distribution of the fluorescent dye particles in the sample 1. Using the set of phase images it is possible to obtain spatial distribution of refractive index inside the measured sample 1.

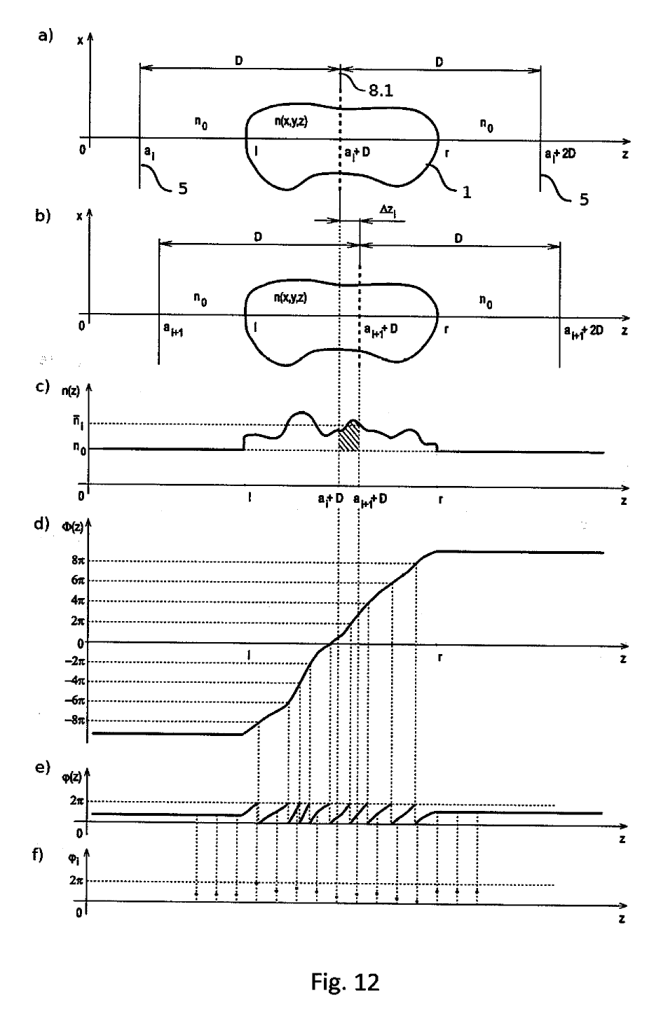

The FIG. 12 a) shows a schematic representation of optical paths of the first arm 9.1 and the second arm 9.2 of interferometric system with the inserted sample 1. The first arm 9.1 is arranged to the left of the object plane 8.1 with respect to the detector 5 while the second arm is on the right towards the detector 5. Both arms have the same length.

Particles of the fluorescent dye arranged in the optical axis z in the point αᵢ+D emit radiation in all directions. The beam passing against the direction of the axis z, i.e. following the first arm 9.1 towards the detector 5 on the left, passes the optical path OPLᵢ(x,y) determined by:

OPLᵢ(x,y)=∫_{α}_{ᵢ}^{l}n₀dz+∫ₗ^{α}^{ᵢ}^{+D}n(x,y,z)dz.

The beam passing in the direction of the axis z, i.e. passing the second arm 9.2 towards the detector 5 on the right, passes the optical path determined by:

OPRᵢ(x,y)=∫_{α}_{ᵢ}_{+D}^{r}n(x,y,z)dz+∫ᵣ^{α}^{ᵢ}^{+2D}n₀dz.

The optical paths difference between the first and the second arm is then determined by:

$$\begin{matrix}{OPD}_{i} ( x , y ) = {OPL}_{i} ( x , y ) - {OPR}_{i} ( x , y ) = \\ = {\int }_{{a}_{i}}^{l} {n}_{0} dz + {\int }_{l}^{{a}_{i} + D} n ( x , y , z ) dz - \\ {\int }_{{a}_{i} + D}^{r} n ( x , y , z ) dz - {\int }_{r}^{{a}_{i} + 2 D} {n}_{0} dz .\end{matrix}$$

In case we shift the sample 1 with respect to the object plane 8.1 for Δzᵢ, i.e. from the position of αᵢ+D into the position of αᵢ₊₁+D, as it is illustrated in the FIG. 12 b), the OPDᵢ changes into OPDᵢ₊₁. Variation of the optical paths difference ΔOPDᵢ(x,y) equals to:

ΔOPDᵢ(x,y)=OPDᵢ₊₁(x,y)−OPDᵢ(x,y)=2∫_{α}_{ᵢ}_{+D}^{α}^{ᵢ₊₁}^{+D}n(x,y,z)−n₀dz.

Then, ΔOPDᵢ(x,y) corresponds to twice the shaded area in the FIG. 12 c). The FIG. 12 c) shows the course of the refractive index n(z) in the chosen picture element in the place given by certain coordinates (x,y) along the axis z. The picture element is therefore, for example, the CCD pixel, or any part of interferogram, thus a group of pixels. The average refractive index n̅ᵢ(x,y) on the interval Δzᵢ is:

$${\overline{n}}_{i} ( x , y ) = \frac{Δ {OPD}_{i} ( x , y )}{2 Δ {z}_{i}} + {n}_{0} .$$

The optical paths difference OPD(x,y) can be converted into the difference of phases φ using the relation

$$φ = \frac{2 π}{λ} OPD ,$$

where λ is the wavelength of emitted radiation. The course φ(z) of the refractive index n(z) shown in the FIG. 12 c) is illustrated in the FIG. 12 d). For ΔOPDᵢ(x,y) it applies that:

$$Δ {OPD}_{i} ( x , y ) = Δ {φ}_{i} ( x , y ) \frac{λ}{2 π} ,$$

where Δφᵢ=φᵢ₊₁−φᵢ is difference between the difference of phases calculated from the first interference image and the difference of phases calculated from the second interference image, and represents the variance of the difference of phases on the interval Δzᵢ, i.e. between the positions αᵢ+Dₐαᵢ₊₁+D of the sample 1.

Phase information reconstructed from the hologram record, e.g. using the method described above, is a discrete set of values φᵢ sampling the function φ=mod_{2π}(φ), which represents modulo 2π of the difference of phases φ. Graphic representation of function φ(z) is shown in the FIG. 12 e). Sampled values φᵢ are illustrated in the FIG. 12 f). Sampling has to be fine enough, i.e. the interval Δzᵢ has to be sufficiently small, so as to enable to reliably unwrap the sampled function φ (remove the discontinuities for 2π), and thus obtain the function ψ=φ+p 2π, where p is a known integer number. The shortest interval m, in which the φ changes for 2π, will be determined provided that it applies that:

$$Δ {φ}_{i} = {φ}_{i + 1} - {φ}_{i} = \frac{2 π}{λ} Δ {OPD}_{i} \leq 2 π \frac{4 π}{λ} {\int }_{{a}_{i} + D}^{{a}_{i + 1} + D} n ( x , y , z ) - {n}_{0} dz \leq 2 π ,$$

Wherein the left part of the inequality will be the highest value for λ=λₘᵢₙ_{ₐ}n=nₘₐₓ. After solving the inequality we get:

$$m = {α}_{i + 1} - {α}_{i} \leq \frac{{λ}_{min}}{2 ( {n}_{max} - {n}_{a} )} .$$

The maximum sampling interval Δzᵢ should be chosen to be smaller than m/3, and thus

$$Δ {z}_{i} \leq \frac{{λ}_{min}}{6 ( {n}_{max} - {n}_{a} )} .$$

Unwrapping the function φ is performed in the determined space (x,y,z). It is not necessary to know the value of parameter p, because to calculate the spatial distribution of refractive index inside the measured sample 1, i.e. the average value of refractive index n̅ᵢ(x,y) on each interval Δzᵢ, it is necessary to know the variance of the difference of phases Δφᵢ, and because it applies that: Δφᵢ=Δψᵢ, it thus applies that:

$${\overline{n}}_{i} ( x , y ) = \frac{Δ {ψ}_{i} ( x , y ) λ}{4 π Δ {z}_{i}} + {n}_{0} .$$

Phase image might also be used to determine the precise position of the fluorescent dye particles in the direction of the optical axis.

The method of measurement of refractive index spatial distribution as well as the interferometric system itself might be used for a number of other arrangements within the scope of protection of this invention, although they are described in relation to their preferred embodiment. It is assumed that the said claims apply also to these variants and adjustments of the arrangement within the true scope of this invention.

### INDUSTRIAL APPLICABILITY

Industrial applicability of the interferometric system and the method of measurement of refractive index spatial distribution according to the present invention is, for example, useful for quantitative monitoring of changes in the spatial distribution of cell mass in time depending on the external conditions, i.e. observing e.g. live cell cultures and microorganisms and their reaction to various external stimuli, e.g. pressure, temperature, toxic substances, drugs, etc. Refractive index of cell structures is thus directly proportional to the density of mass contained in these structures.

### LIST OF REFERENCE SIGNS

1 sample
2.1 first input imaging system
2.2 second input imaging system
3.1 first output imaging system
3.2 second output imaging system
4.1 first extender
4.2 second extender
5 detector
6 external source of radiation
7 diffraction grating
7.1 first diffraction grating
7.2 second diffraction grating
8.1 object plane
8.2 output image plane
8.3 first primary image plane
8.4 second primary image plane
9.1 first arm
9.2 second arm
10 common imaging system
11 beam axis in the zero diffraction order
12 output system of reflectors

1. A method of measuring refractive index spatial distribution of a luminescent sample in an interferometric system comprising an external source of radiation, a first branch and a second branch, a system of reflectors, and a detector arranged in an output image plane and connected to a computing unit, where the first branch comprises a first input imaging system and a first output imaging system, and the second branch comprises a second imaging system, wherein the first input imaging system and the second input imaging system are arranged on an axis z and against each other so that the first and second input imaging system have a mutual image plane in which the luminescent sample is arranged, and which is optically conjugated with the output image plane, the method comprising the steps of:
(a) exciting luminescent particles contained in the sample using an external source of radiation, wherein the luminescent particles then emit radiation, wherein the emitted radiation passes through the first branch and the second branch and reaches the detector, where the radiation from each branch interferes with the radiation passing through the other branch;
(b) recording a first interferogram on the detector and saving the first interferogram to a computing unit;
(c) shifting the luminescent sample in a direction of the axis z;
(d) recording a second interferogram and saving the second interferogram to the computing unit;
(e) calculating an amplitude of waves emitted by the luminescent sample and a difference of phases between the radiation passing through the first branch and the second branch from the first and the second interferogram;
(f) calculating a difference between the difference of the phases from the first interferogram and the difference of the phases from the second interferogram; and
(g) calculating an average value of refractive index in volumetric element defined by a size of a picture element and a size of the shift of the luminescent sample along the axis z.

2. The method of measurement of refractive index spatial distribution according to the claim 1, wherein step (g) further comprises the step of calculating the average value of refractive index n̅ᵢ(x,y) in the volumetric element of the luminescent sample by using the relation
$${\overline{n}}_{i} ( x , y ) = \frac{Δ {OPD}_{i} ( x , y )}{2 Δ {z}_{i}} + {n}_{0} = \frac{Δ {ψ}_{i} ( x , y ) λ}{4 π Δ {z}_{i}} + {n}_{0} ,$$
where ΔOPDᵢ is a variation of optical paths differences, n₀ is refractive index of an environment surrounding the luminescent sample, Δzᵢ is size of the shift of the luminescent sample along the axis z, λ is a wavelength of the radiation emitted by the luminescent sample, and Δψᵢ is a variance of the difference of phases on an interval Δzᵢ.

3. The method of measurement of refractive index spatial distribution according to the claim 1, wherein an image element of the first and the second phases with the same coordinates (x,y) is used to calculate the variance of the difference of phases.

4. Interferometric system comprising an external source of radiation, a first branch and a second branch, a system of reflectors, and a detector arranged in an output image plane, where the first branch comprises a first input imaging system and a first output imaging system, and the second branch comprises a second input imaging system, wherein the first input imaging system and the second input imaging system are arranged on an axis z and against each other so that the first and second input imaging systems have a common object plane optically conjugated with the output image plane, wherein the system further comprises at least one diffraction grating located in a plane optically conjugated with the object plane to create an achromatic hologram with spatial carrier frequency in the output image plane.

5. The interferometric system according to the claim 4, further comprising an extender for setting identical optical path lengths of both branches.

6. The interferometric system according to the claim 4, wherein the second branch further comprises a second output imaging system.

7. The interferometric system according to claim 4, wherein the system of reflectors is adjusted so that a non-zero diffraction order of radiation diffracted on the diffraction grating is directed onto the detector.

8. The interferometric system according to claim 4, wherein the radiation from the external source, which interacted with a sample, is used to obtain visual information.

9. The interferometric system according to the claim 7, wherein the visual information is obtained from the radiation emitted by the sample.

10. The interferometric system according to claim 4, wherein a degree of coherence of detected radiation is low.

11. The interferometric system according to claim 6, wherein the first output imaging system and the second output imaging system have at least one mutual optical element.

12. The interferometric system according to claim 4, wherein the diffraction grating is designed as transmission amplitude diffraction grating or transmission phase diffraction grating.

13. The interferometric system according to claim 4, wherein the diffraction grating is designed as a reflection amplitude diffraction grating or reflection phase diffraction grating.

14. The interferometric system according to claim 4, further comprises at least one element with variable focal length.

15. The interferometric system according to claim 4, wherein the diffraction grating is replaceable.

16. The interferometric system according to claim 4, wherein a computing unit for numerical processing of the output is connected to the detector.
